(19) United States
(12) Patent Application Publication
(10) Pub. No.: US 2015/0096851 A1
(43) Pub. Date: Apr. 9, 2015

(54) Friction Brake Pad

(71) Applicant: Robert Bosch GmbH, Stuttgart (DE)

(72) Inventor: Roland Raab, Wiesloch (DE)

(21) Appl. No.: 14/383,594

(22) PCT Filed: Mar. 11, 2013
(86) PCT No.: PCT/EP2013/054876

§ 371 Date: Sep. 8, 2014

(30) Foreign Application Priority Data
Mar. 9, 2012 (DE) 10 2012 203 760.8

(51) Int. Cl. F16D 69/02; F16D 65/092

(52) U.S. Cl. CPC F16D 69/02; F16D 65/092; F16D 2069/002
USPC 188/251 A

(57) ABSTRACT

A friction brake pad for a friction brake comprises at least one corrosion prevention element located within a friction surface. The corrosion prevention element is flush with the friction surface and is configured to wear with the friction brake pad. The at least one corrosion prevention element may be formed of a baser metal than gray cast iron.

The invention relates to a friction brake pad for a friction brake, in particular to a friction brake of a motor vehicle, having the features of the preamble of claim 1. In particular, the invention is provided for a disk brake, but it can likewise be used for a drum brake or some other type of brake.

### PRIOR ART

Friction brake pads for friction brakes of motor vehicles are composed of synthetic resin, in which metal particles are embedded, for example. Copper or brass particles are known. To increase strength, the synthetic resin can contain fibers, and further possible additives are fillers and/or powdered graphite.

International Patent Application WO 93/22 580 A1 proposes adding particles of a base metal, namely calcium, lithium, sodium or potassium, i.e. the four basest metals, to the synthetic resin instead of brass particles. The term “base” and also its opposite “noble” refer here to the electrochemical series. The base metal particles have an action similar to what is termed a “sacrificial anode”, preventing or at least reducing corrosion of a brake disk composed of a more noble metal, normally gray cast iron or steel. On contact with water, e.g. spray or rainwater or atmospheric humidity, the baser metal, i.e. the base metal particles embedded in the friction brake pad, corrodes, not the gray cast iron or steel brake disk.

To prevent corrosion of a brake disk, the abstract of Japanese Patent Application JP 7 109 362 A proposes a friction brake pad, the pH of which is 9 or higher. This is achieved by adding an alkaline substance, such as slaked lime, sodium nitrite or an alkaline powder, to the pad material of the friction brake pad.

### DISCLOSURE OF THE INVENTION

The friction brake pad according to the invention having the features of claim 1 likewise achieves corrosion protection of a brake disk or of a brake drum or some other braking element made of gray cast iron or steel by means of a baser metal than gray cast iron, in particular by means of a baser metal (claim 2) and preferably by means of zinc (claim 3). However, in contrast to the prior art, the baser material is not embedded in a distributed manner in the form of particles in a synthetic resin matrix; instead, the friction brake pad has at least one corrosion prevention element composed of the material baser than gray cast iron which is flush with a friction surface of the friction brake pad and wears together with the friction brake pad, i.e. remains flush with the friction surface of the friction brake pad for the entire duration of use until complete abrasion. The friction surface is the surface of the friction brake pad which faces the brake disk or some other braking element, which comes into contact with the brake disk during braking and which is pressed against the brake disk. Unlike the metal particles in the prior art, which typically have a maximum diameter of a few tens of micrometers, are not normally visible to the naked eye and can therefore also be referred to as microscopic in size, the at least one corrosion prevention element of the friction brake pad according to the invention is macroscopic, i.e. visible to the naked eye, its smallest dimension being at least a few tenths of a millimeter to several tenths of a millimeter, preferably about 1 mm or above. In contrast to the prior art, the friction brake pad according to the invention does not comprise a (particulate) composite material with metal particles embedded in a matrix, but the at least one corrosion prevention element is within or adjacent to the friction brake pad with a clear boundary between the corrosion prevention element and the friction brake pad. The friction brake pad as such, apart from the corrosion prevention element or elements, can be a composite material.

The height of the at least one corrosion prevention element is preferably equal to the thickness of the friction brake pad, i.e. extends continuously from the friction surface to a rear side of the friction brake pad, said side facing away from the brake disk and, for example, being mounted on a brake carrier plate.

During braking, brake dust, i.e. particles in the form of abraded material, is formed, and comes away from the friction brake pads. The brake dust of the friction brake pad according to the invention contains particles of the corrosion prevention element, which is composed of the material baser than gray cast iron. The particles are deposited on the brake disk, on a brake and on other parts in the immediate vicinity of the brake disk. They have an effect similar to that of a sacrificial anode, i.e. on contact with water or moisture it is the brake dust particles of baser material from the corrosion prevention element of the friction brake pad which corrode and not the brake disk. The corrosion prevention element also acts in the manner of a sacrificial anode and protects the brake disk from corrosion.

If the corrosion prevention element according to claim 3 comprises zinc, corrosion protection is accomplished by mechanical zinc-coating of a brake disk through the application of a zinc layer during braking. Mechanical coating of a brake disk as a form of corrosion protection through the application of a layer consisting of the material of the corrosion prevention element to a brake disk during braking is also possible in the case of other materials for the corrosion prevention element. Other possible metals are chromium, titanium, aluminum or magnesium. This list is not exhaustive, and the material is not restricted to metals.

Although the invention is provided for disk brakes, it is not restricted to these but can also be used for other types of brake, e.g. drum brakes.

The subject matter of the dependent claims are advantageous embodiments and developments of the invention specified in claim 1.

### BRIEF DESCRIPTION OF THE DRAWING

The invention is explained in greater detail below by means of illustrative embodiments shown in the drawing. The two figures show two friction brake pads according to the invention in perspective.

### EMBODIMENTS OF THE INVENTION

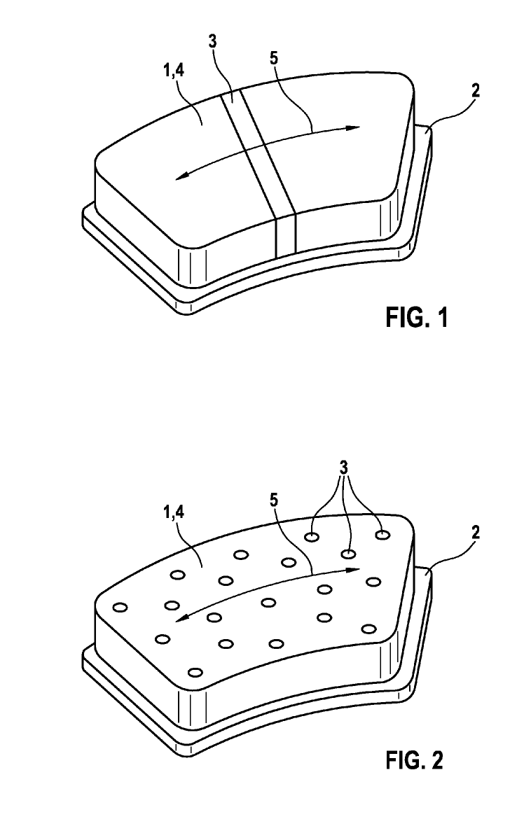

The two figures show two friction brake pads 1 for motor vehicle disk brakes (not shown). As is conventional, the friction brake pads 1 are arranged nondetachably on a carrier plate 2, which is stiff in bending and torsion and is made of steel, for example. The friction brake pads 1 are composed of a conventional pad material, e.g. a particulate composite material having a matrix composed of a synthetic resin, in which copper particles and possibly other additives are embedded. In FIG. 1, the friction brake pad 1 according to the invention is traversed transversely by a strip-shaped corrosion prevention element 3 composed of zinc, i.e. a baser metal than gray cast iron or steel, of which brake disks are typically composed when they are composed of metal. Although use of the friction brake pad 1 with brake disks composed of a nonrusting metal or some other nonrusting material is not envisaged, it is also not excluded. The height of the corrosion prevention element 3 is equal to the thickness of the friction brake pad 1, i.e. it extends from the carrier plate 2 to a friction surface 4 of the friction brake pad 1, with which the corrosion prevention element 3 is flush. The friction surface 4 is the surface of the friction brake pad 1 which is pressed against a brake disk (not shown) during braking. The corrosion prevention element 3 wears together with the friction brake pad 4 and is and remains flush with the friction surface 4 during the entire duration of use of the friction brake pad 1. The corrosion prevention element 3 is several millimeters wide and extends transversely to a direction of rotation of a brake disk (not shown) from a radially inner edge to a radially outer edge of the friction brake pad 1. The terms “radially inner” and “radially outer” likewise refer to the brake disk (not shown) and to the arrangement of the friction brake pad 1 in a brake disk relative to an associated axis of rotation of the brake disk (not shown) and of an associated vehicle wheel. In the drawing, the direction of rotation of the brake disk is indicated by a double arrow and is here referred to as friction direction 5. Owing to the fact that the corrosion prevention element 3 extends over the entire width of the friction brake pad 1, transversely to the friction direction 5, it brushes over the entire friction surface of the associated brake disk during braking, i.e. the brake disk surface in the form of a disk with a circular hole, which the friction brake pad 1 brushes over during braking.

During braking, brake dust occurs due to abrasion, i.e. particles which, in the case of the friction brake pad 1 according to the invention, also contains particles of the material of the corrosion prevention element 3, i.e. zinc particles. The brake dust, including the zinc particles contained therein, reaches the brake disk and parts such as a brake caliper in the immediate vicinity of the brake disk. Zinc is a baser metal than the gray cast iron or steel of a brake disk. The zinc particles have an effect similar to that of a “sacrificial anode”, i.e. on contact with water or atmospheric moisture it is not the brake disk which corrodes but the baser zinc particles in the brake dust of the friction brake pad 1. The brake disk is protected from corrosion.

In addition, zinc from the corrosion prevention element is applied mechanically as a corrosion prevention layer to the friction surfaces of the brake disk during braking.

In contrast to FIG. 1, the friction brake pad 1 in FIG. 2 does not have a strip-shaped corrosion prevention element 3 but has a number of corrosion prevention elements 3 in the form of cylindrical pins, which are arranged in a manner distributed uniformly or non-uniformly over the friction surface 4 in congruent holes in the friction brake pad 1. The height of the corrosion prevention elements 3 is equal to the thickness of the friction brake pad 1, and they extend from the pad carrier plate 2 to the friction surface 4, with which they are flush. The corrosion prevention elements 3 are preferably arranged in a manner distributed over the friction surface 4 in such a way that they cover the friction surface 4 of the friction brake pad 1 over the entire width thereof from the radially inner to the radially outer edge, preferably without gaps, transversely to the friction direction 5, i.e. transversely to the direction of rotation of the brake disk (not shown), so that they brush over the entire friction surface of the brake disk (not shown) during braking. However, gaps between the corrosion prevention elements 3 when viewed across the width of the friction brake pad 1 do not impair corrosion prevention by the zinc particles in the brake dust of the friction brake pad 1, which act in a manner similar to a sacrificial anode.

With the exception of the shape and distribution of the corrosion prevention elements 3, the friction brake pad 1 in FIG. 2 is of a design which coincides with the friction brake pad 1 in FIG. 1 and functions in the same way. For purposes of explaining FIG. 2, attention is drawn to the explanations of FIG. 1 by way of supplementary information.

The invention is not restricted to the number, shape and distribution of the corrosion prevention elements 3 illustrated and explained.

In addition to uncoated brake disks made of gray cast iron or steel, the friction brake pad 1 according to the invention is also provided for brake disks which have an anti-wear coating. Such surface coatings are applied to brake disks or at least to the friction surfaces thereof thermally, e.g. by flame spraying. They comprise metallic carbides, e.g. chromium carbide and/or tungsten carbide, which is embedded in a metallic matrix composed of nickel or cobalt, for example. To simplify, brake disks of this kind are also referred to as coated brake disks. With these, there is the risk of delamination, i.e. detachment of the surface coating, if moisture penetrates through very fine cracks in the surface coating and the brake disk is undermined by corrosion under the surface coating.

Here too, the friction brake pad 1 according to the invention counteracts corrosion of the brake disk and hence delamination.

1. A friction brake pad for a friction brake, comprising:
a friction surface; and
at least one corrosion prevention element located within the friction surface,
wherein the at least one corrosion prevention element is flush with the friction surface and configured to wear with the friction brake pad.

2. The friction brake pad as claimed in claim 1, wherein the at least one corrosion prevention element is formed from a metal baser than gray cast iron.

3. The friction brake pad as claimed in claim 1, wherein the at least one corrosion prevention element is formed from zinc.

4. The friction brake pad as claimed in claim 1, wherein a height of the at least one corrosion prevention element is equal to a thickness of the friction brake pad.

5. The friction brake pad as claimed in claim 1, wherein the at least one corrosion prevention element extends across a width of the friction brake pad, transversely to a friction direction.

6. The friction brake pad as claimed in claim 1, wherein the at least one corrosion prevention element comprises corrosion prevention elements distributed over the friction surface.

7. The friction brake pad as claimed in claim 1, wherein the friction brake pad is configured as a motor vehicle friction brake pad.
